(19) United States
(12) Patent Application Publication
(10) Pub. No.: US 2025/0111791 A1
(43) Pub. Date: Apr. 3, 2025

(54) Statistical Estimation of Local Minimum Flyable AGLs based on Probabilities of Planned Flights Intersecting Terrain Estimates

(71) Applicant: Wing Aviation LLC, Palo Alto, CA (US)

(72) Inventors: Sai Bhargav Yalamanchi, Mountain View, CA (US); Dinuka Malin Wickramasinghe Abeywardena, Mountain View, CA (US); Aditya Undurti, Dublin, CA (US); Kyle David Julian, Mountain View, CA (US); Brandon Lane Jones, Palo Alto, CA (US)

(21) Appl. No.: 18/478,354

(22) Filed: Sep. 29, 2023

(51) Int. Cl. G08G 5/00; G06N 7/01; G08G 5/04

(52) U.S. Cl. CPC G08G 5/55; G06N 7/01; G08G 5/34; G08G 5/56; G08G 5/57; G08G 5/59; G08G 5/80

(57) ABSTRACT

A method comprises determining an occupancy grid of an area for unmanned aerial vehicle (UAV) navigation. The method further comprises determining, based on the occupancy grid, a candidate flyable airspace through which to permit UAV navigation and determining, by a UAV route planner, a plurality of UAV flight paths through the candidate flyable airspace. The method further comprises determining, based on the occupancy grid, a probability value of the plurality of UAV flight paths intersecting an occupied volume. The method additionally comprises determining whether the probability value of the plurality of UAV flight paths intersecting the occupied volume is below a threshold value and, based on determining that the probability value of the plurality of UAV flight paths intersecting the occupied volume is below the threshold value, validating the candidate flyable airspace for the UAV route planner to plan a route for a UAV to navigate through the area.

### BACKGROUND

An unmanned vehicle, which may also be referred to as an autonomous vehicle, is a vehicle capable of travel without a physically-present human operator. An unmanned vehicle may operate in a remote-control mode, in an autonomous mode, or in a partially autonomous mode.

When an unmanned vehicle operates in a remote-control mode, a pilot or driver that is at a remote location can control the unmanned vehicle via commands that are sent to the unmanned vehicle via a wireless link. When the unmanned vehicle operates in autonomous mode, the unmanned vehicle typically moves based on pre-programmed navigation waypoints, dynamic automation systems, or a combination of these. Further, some unmanned vehicles can operate in both a remote-control mode and an autonomous mode, and in some instances may do so simultaneously. For instance, a remote pilot or driver may wish to leave navigation to an autonomous system while manually performing another task, such as operating a mechanical system for picking up objects, as an example.

Various types of unmanned vehicles exist for various different environments. For instance, unmanned vehicles exist for operation in the air, on the ground, underwater, and in space. Examples of unmanned aerial vehicles (UAVs) include quad-copters and tail-sitter UAVs, among others. Unmanned vehicles also exist for hybrid operations in which multi-environment operation is possible. Examples of hybrid unmanned vehicles include an amphibious craft that is capable of operation on land as well as on water or a floatplane that is capable of landing on water as well as on land. Other examples are also possible.

### SUMMARY

Examples disclosed herein include systems and methods for generating flyable airspaces through which flight paths may be planned for UAVs. In order to generate a flyable airspace, a candidate flyable airspace may be evaluated. A computing system may determine and simulate various different flight paths within the candidate flyable airspace to determine a probability value of the flight paths intersecting an occupied volume. Based on the probability value being below a threshold value, the candidate flyable airspace may be validated and may then be used as a flyable airspace to determine UAV flight paths.

In an embodiment, a method is provided. The method includes determining an occupancy grid of an area for unmanned aerial vehicle (UAV) navigation, where the occupancy grid comprises occupancy information for a plurality of grid cells in the area. The method also includes determining, based on the occupancy grid, a candidate flyable airspace through which to permit UAV navigation. The method further includes determining, by a UAV route planner, a plurality of UAV flight paths through the candidate flyable airspace. The method further includes determining, based on the occupancy grid, a probability value of the plurality of UAV flight paths intersecting an occupied volume. The method additionally includes determining whether the probability value of the plurality of UAV flight paths intersecting the occupied volume is below a threshold value. The method also includes based on determining that the probability value of the plurality of UAV flight paths intersecting the occupied volume is below the threshold value, validating the candidate flyable airspace for the UAV route planner to plan a route for a UAV to navigate through the area.

In another embodiment, a computing device is provided. The computing device comprises one or more processors and data storage including at least computer-executable instructions stored thereon that, when executed by the one or more processors, cause the computing device to perform functions. The functions comprise determining an occupancy grid of an area for unmanned aerial vehicle (UAV) navigation, wherein the occupancy grid comprises occupancy information for a plurality of grid cells in the area. The functions also comprise determining, based on the occupancy grid, a candidate flyable airspace through which to permit UAV navigation. The functions further comprise determining, by a UAV route planner, a plurality of UAV flight paths through the candidate flyable airspace. The functions additionally comprise determining, based on the occupancy grid, a probability value of the plurality of UAV flight paths intersecting an occupied volume. The functions also comprise determining whether the probability value of the plurality of UAV flight paths intersecting the occupied volume is below a threshold value. The functions further comprise based on determining that the probability value of the plurality of UAV flight paths intersecting the occupied volume is below the threshold value, validating the candidate flyable airspace for the UAV route planner to plan a route for a UAV to navigate through the area.

In a further embodiment, a non-transitory computer readable medium is provided. The non-transitory computer readable medium having stored thereon instructions, that when executed by one or more processors of a computing device, cause the computing device to perform functions comprising determining an occupancy grid of an area for unmanned aerial vehicle (UAV) navigation, wherein the occupancy grid comprises occupancy information for a plurality of grid cells in the area. The functions further comprise determining, based on the occupancy grid, a candidate flyable airspace through which to permit UAV navigation. The functions additionally comprise determining, by a UAV route planner, a plurality of UAV flight paths through the candidate flyable airspace. The functions also comprise determining, based on the occupancy grid, a probability value of the plurality of UAV flight paths intersecting an occupied volume. The functions additionally comprise determining whether the probability value of the plurality of UAV flight paths intersecting the occupied volume is below a threshold value. The functions further comprise based on determining that the probability value of the plurality of UAV flight paths intersecting the occupied volume is below the threshold value, validating the candidate flyable airspace for the UAV route planner to plan a route for a UAV to navigate through the area.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1A is an illustration of an unmanned aerial vehicle, in accordance with example embodiments.

FIG. 1B is a simplified illustration of an unmanned aerial vehicle, in accordance with example embodiments.

FIG. 1C is a simplified illustration of an unmanned aerial vehicle, in accordance with example embodiments.

FIG. 1D is a simplified illustration of an unmanned aerial vehicle, in accordance with example embodiments.

FIG. 1E is a simplified illustration of an unmanned aerial vehicle, in accordance with example embodiments.

FIG. 2 is a simplified block diagram illustrating components of an unmanned aerial system, in accordance with example embodiments.

FIG. 3 is a simplified block diagram illustrating a distributed UAV system, in accordance with example embodiments.

FIG. 4 is a block diagram showing an example arrangement for an aerial transport provider control system, in accordance with example embodiments.

FIG. 5 is a block diagram of a method, in accordance with example embodiments.

FIG. 6 illustrates part of an example occupancy grid, in accordance with example embodiments.

FIG. 7 illustrates altitudes and margins defining a candidate flyable airspace, in accordance with example embodiments.

FIG. 8 illustrates flight paths through a candidate flyable airspace, in accordance with example embodiments.

FIG. 9 illustrates probabilities of UAV intersection with occupied areas, in accordance with example embodiments.

FIG. 10 illustrates altitudes and margins defining another candidate flyable airspace, in accordance with example embodiments.

FIG. 11 illustrates a flyable airspace, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purposes of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

Unmanned aerial vehicles (UAVs) may be used to deliver various items to customers. For example, a UAV may be tasked with picking up a payload containing an item from a location of a merchant and delivering the payload to a customer's residence, commercial building, or other final location. One issue that may arise during this delivery process is determining a flight path through which the UAV may navigate to deliver this payload. Flight paths may be obstructed by various obstacles, including for example, buildings, powerlines, trees, windmills, among other obstacles. Navigating a flight path that intersects and/or is in proximity to one or more of these obstacles may cause damage to the UAV, the payload, the contents of the payload, the obstacle, and/or any objects on the ground.

Therefore, it may be important to ensure that the flight path of the UAV does not intersect one or more of these obstacles. In some examples, to generate flight paths that do not intersect with these obstacles, the computing system may reference a map of the environment, e.g., a digital surface model (DSM), which may indicate the predicted heights of one or more obstacles in the environment. The map of the environment may be determined by using sensor data collected by one or more UAVs tasked with surveying the environment and/or while delivering various payloads. Flight paths for the UAVs may be determined based on a candidate flyable airspace, which may be, for example, an area above the heights indicated by the DSM. However, in some instances, the map of the environment may be inaccurate, perhaps due to the maps being outdated or stale, inaccurate sensor data, and/or unreliable sensor processing procedures.

Provided herein are methods for generating candidate flyable airspaces that may facilitate obstacle avoidance in UAV flight path determination. In some examples, a computing system may determine and simulate various flight paths within a candidate flyable airspace to determine a probability value of the determined flight paths intersecting an occupied volume. If the computing system determines that the probability is below a threshold value, the computing system and/or a fleet of UAVs may use the candidate flyable airspace to plan flight paths. Whereas, if the computing system determines that the probability is above a threshold value, the computing system may determine a different candidate flyable airspace and evaluate that candidate flyable airspace to determine whether flight paths can be planned using that candidate flyable airspace.

In some examples, to determine and/or evaluate a candidate flyable airspace, the computing system may use an occupancy grid, which may include a plurality of grid cells. The occupancy grid may be determined from sensor data from UAVs and/or other sensors. Each of these grid cells may represent an area in the environment and may be associated with an occupancy value indicative of the probability that the area in the environment represented by the grid cell is occupied. For example, if a grid cell has an occupancy value of 0.95, the computing system may determine that the area (e.g., a 1 meter by 1 meter by 1 meter area) in the environment represented by that grid cell has a 95% chance of being occupied and a 5% chance of not being occupied.

Based on the occupancy grid, the computing system may generate a candidate flyable airspace through which to permit UAV navigation. In some examples, determining the candidate flyable airspace may include determining an estimated DSM based on the occupancy grid. The estimated DSM may include estimated altitudes representing the surface at different locations. For example, the estimated DSM may indicate that a 1 meter by 1 meter area in the environment is occupied up to an altitude of 10 meters (e.g., perhaps due to a building in the 1 meter by 1 meter area that has a height of 10 meters). The candidate flyable airspace may then include the area above that altitude (e.g., above 10 meters above the ground), and the computing system may determine UAV flight paths through that area.

Additionally and/or alternatively, the computing system may also determine margins, such that the candidate flyable airspace is an area above the altitudes from the DSM by at least the associated margins. Margins may help facilitate determining candidate flyable airspaces, particularly when the accuracy of the altitude information is uncertain. For example, the previously described 1 meter by 1 meter area in the environment may be associated with having a margin value of one meter. The candidate flyable airspace for the 1 meter by 1 meter area in the environment may then be the airspace above the altitude from the DSM and the margin value, e.g., the airspace above 11 meters.

Other examples of generating candidate flyable airspace may also be possible. For instance, the computing system may store a predetermined DSM, and the computing system may use the heights indicated by the predetermined DSM as altitude information. In some examples, the predetermined DSM may also include an indication of confidence values, and the computing system may determine margin information based on the confidence values. In particular, the computing system could determine lower margin values for areas associated with higher confidence values and higher margin values for areas associated with lower confidence values.

Based on the candidate flyable airspace, the computing system may determine a plurality of UAV flight paths. In some examples, the computing system may use a UAV route planner, which may take an input of at least the candidate flyable airspace and output a plurality of UAV flight paths that hypothetical UAVs may take through the environment. Additionally and/or alternatively, the computing system may determine the UAV flight paths based on a plurality of orders, a plurality of delivery locations, a plurality of merchants, and/or a particular order flow (e.g., order flow during peak times).

The computing system may then simulate the UAV flights to determine a probability value of the UAV flight paths intersecting an occupied volume, which may involve using the occupancy grid. In particular, the occupancy grid may indicate that an area in the environment has a 0.15 probability of being occupied. When the flight is simulated, the computing system may use this probability value, along with probability values of other areas in the environment, to determine a probability value of UAV flight paths intersecting an occupied volume, as indicated by these areas in the environment. This process of determining the probability value of the UAV flight paths intersecting the occupied volume may be based on one or more assumptions, including, for example, an assumption that an occupancy of a grid cell is independent of occupancy of other grid cells of the occupancy grid and/or an assumption that the DSM or other map accurately describes heights of areas in the environment, among other assumptions. Additionally and/or alternatively, the computing system may run a simulation for each batch of flight paths determined from different batches of merchants, delivery locations and/or order flows and compute an average of the calculated probabilities.

The computing system may then verify whether the determined probability value of the plurality of UAV flight paths intersecting the occupied volume is below a threshold value. Ensuring that the determined probability value is not too high helps facilitate the determination of flight paths that do not intersect with obstacles in the environment and cause damage to the UAV, the payload, the contents of the payload, the obstacle, and/or any objects on the ground.

After verifying the determined probability value, the computing system may then use and/or transmit the candidate flyable airspace to generate flyable paths for a fleet of UAVs operating in the environment. If the verification is unsuccessful (e.g., if the computing system determines that the determined probability value is above the threshold value), the computing system may then generate a new candidate flyable airspace, and the computing system may repeat the steps described above to determine whether the new candidate airspace can be used to generate flights for the fleet of UAVs.

Reference will now be made in detail to various embodiments, examples of which are illustrated in the accompanying drawings. In the following detailed description, numerous specific details are set forth in order to provide a thorough understanding of the present disclosure and the described embodiments. However, the present disclosure may be practiced without these specific details. In other instances, well-known methods, procedures, and components, and circuits have not been described in detail so as not to unnecessarily obscure aspects of the embodiments.

### II. Example Unmanned Vehicles

Herein, the terms “unmanned aerial system” and “UAV” refer to any autonomous or semi-autonomous vehicle that is capable of performing some functions without a physically present human pilot. A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “unmanned aerial vehicle system” (UAVS), or “unmanned aerial vehicle” may also be used to refer to a UAV.

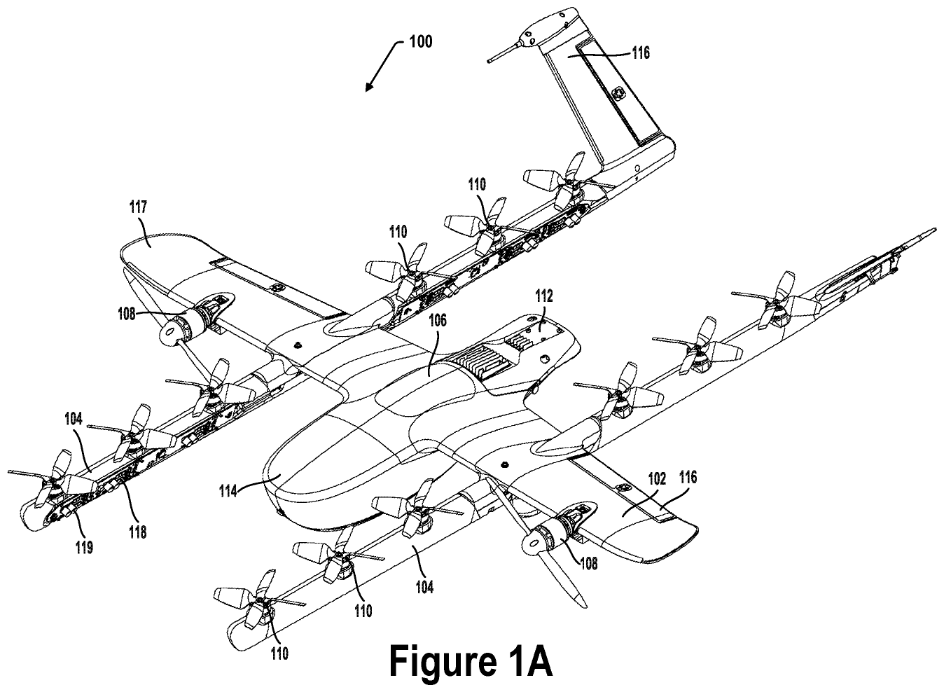

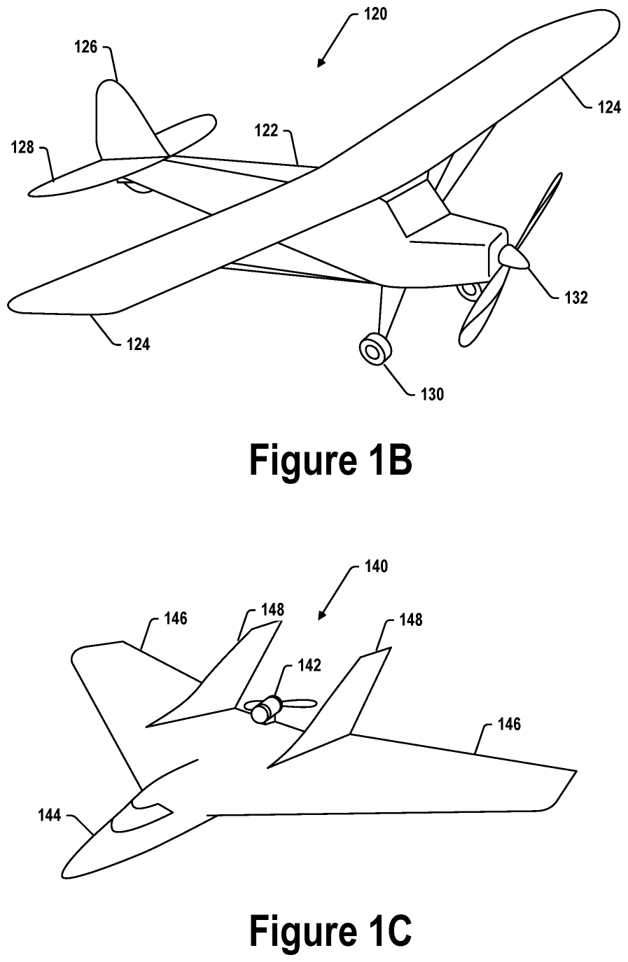

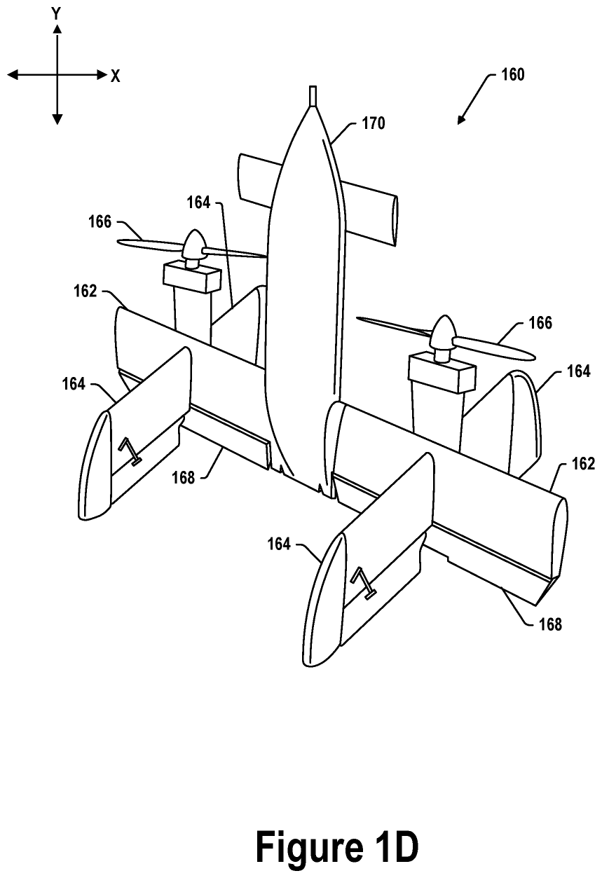

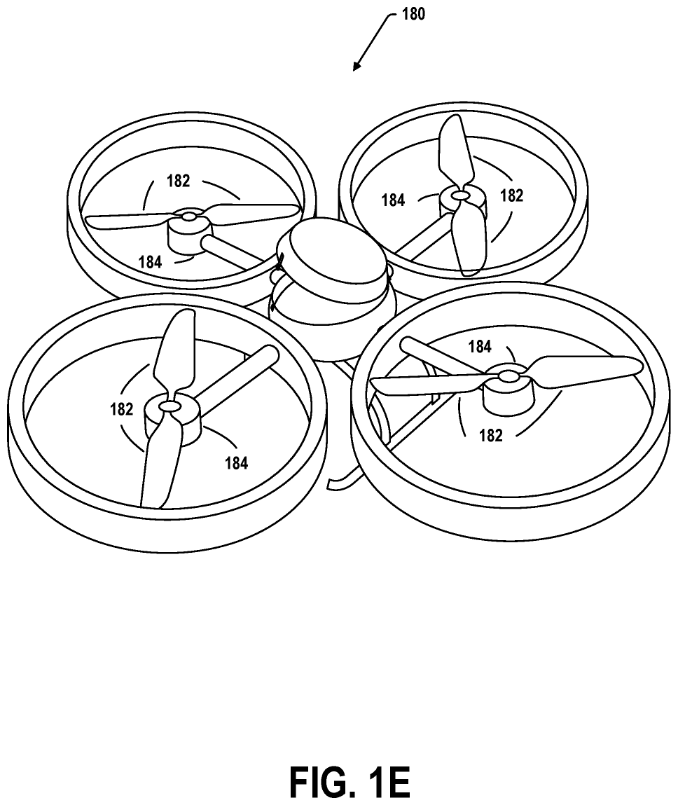

FIG. 1A is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per the boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, UAVs with more wings (e.g., an “x-wing” configuration with four wings), are also possible. Although FIG. 1 illustrates two wings 102, two booms 104, two horizontal propulsion units 108, and six vertical propulsion units 110 per boom 104, it should be appreciated that other variants of UAV 100 may be implemented with more or less of these components. For example, UAV 100 may include four wings 102, four booms 104, and more or less propulsion units (horizontal or vertical).

Similarly, FIG. 1B shows another example of a fixed-wing UAV 120. Fixed-wing UAV 120 includes fuselage 122, two wings 124 with an airfoil-shaped cross section to provide lift for UAV 120, vertical stabilizer 126 (or fin) to stabilize the plane's yaw (turn left or right), horizontal stabilizer 128 (also referred to as an elevator or tailplane) to stabilize pitch (tilt up or down), landing gear 130, and propulsion unit 132, which can include a motor, shaft, and propeller.

FIG. 1C shows an example of UAV 140 with a propeller in a pusher configuration. The term “pusher” refers to the fact that propulsion unit 142 is mounted at the back of UAV 140 and “pushes” the vehicle forward, in contrast to the propulsion unit 142 being mounted at the front of UAV 140. Similar to the description provided for FIGS. 1A and 1B, FIG. 1C depicts common structures used in a pusher plane, including fuselage 144, two wings 146, vertical stabilizers 148, and propulsion unit 142, which can include a motor, shaft, and propeller.

FIG. 1D shows an example tail-sitter UAV 160. In the illustrated example, tail-sitter UAV 160 has fixed wings 162 to provide lift and allow UAV 160 to glide horizontally (e.g., along the x-axis, in a position that is approximately perpendicular to the position shown in FIG. 1D). However, fixed wings 162 also allow tail-sitter UAV 160 to take off and land vertically on its own.

For example, at a launch site, tail-sitter UAV 160 may be positioned vertically (as shown) with fins 164 and/or wings 162 resting on the ground and stabilizing UAV 160 in the vertical position. Tail-sitter UAV 160 may then take off by operating propellers 166 to generate an upward thrust (e.g., a thrust that is generally along the y-axis). Once at a suitable altitude, tail-sitter UAV 160 may use flaps 168 to reorient itself in a horizontal position, such that fuselage 170 is closer to being aligned with the x-axis than the y-axis. Positioned horizontally, propellers 166 may provide forward thrust so that tail-sitter UAV 160 can fly in a similar manner as a typical airplane.

Many variations on the illustrated fixed-wing UAVs are possible. For instance, fixed-wing UAVs may include more or fewer propellers, and/or may utilize a ducted fan or multiple ducted fans for propulsion. Further, UAVs with more wings (e.g., an “x-wing” configuration with four wings), with fewer wings, or even with no wings, are also possible.

As noted above, some embodiments may involve other types of UAVs, in addition to or in the alternative to fixed-wing UAVs. For instance, FIG. 1E shows an example of rotorcraft 180 that is commonly referred to as a multicopter. Multicopter 180 may also be referred to as a quadcopter, as it includes four rotors 182. It should be understood that example embodiments may involve a rotorcraft with more or fewer rotors than multicopter 180. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to multicopter 180 in greater detail, four rotors 182 provide propulsion and maneuverability for multicopter 180. More specifically, each rotor 182 includes blades that are attached to motor 184. Configured as such, rotors 182 may allow multicopter 180 to take off and land vertically, to maneuver in any direction, and/or to hover. Further, the pitch of the blades may be adjusted as a group and/or differentially, and may allow multicopter 180 to control its pitch, roll, yaw, and/or altitude.

It should be understood that references herein to an “unmanned” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of unmanned aerial vehicle.

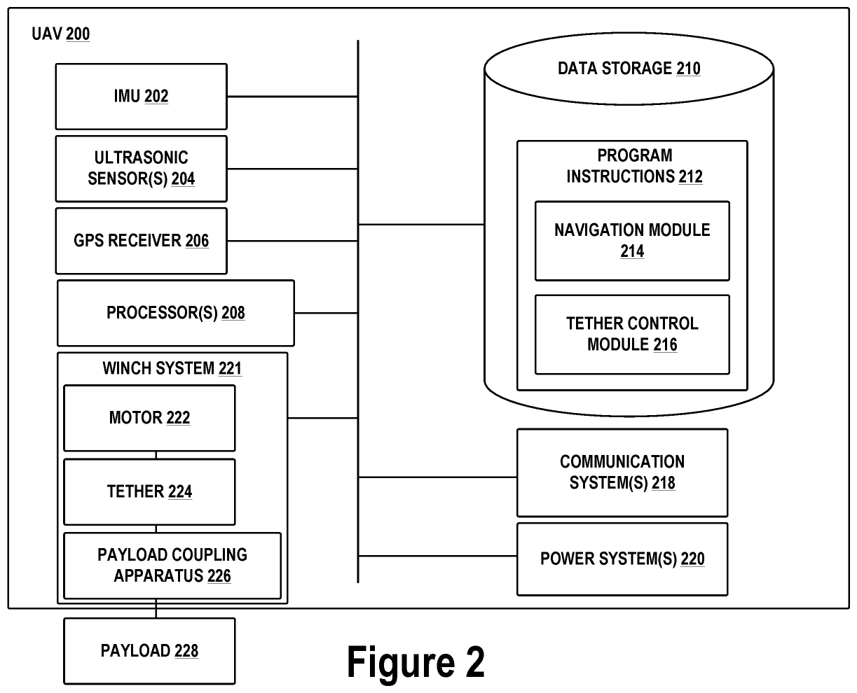

FIG. 2 is a simplified block diagram illustrating components of UAV 200, according to an example embodiment. UAV 200 may take the form of, or be similar in form to, one of UAVs 100, 120, 140, 160, and 180 described in reference to FIGS. 1A-1E. However, UAV 200 may also take other forms.

UAV 200 may include various types of sensors, and may include a computing system configured to provide the functionality described herein. In the illustrated embodiment, the sensors of UAV 200 include inertial measurement unit (IMU) 202, ultrasonic sensor(s) 204, and GPS receiver 206, among other possible sensors and sensing systems.

In the illustrated embodiment, UAV 200 also includes processor(s) 208. Processor 208 may be a general-purpose processor or a special purpose processor (e.g., digital signal processors, application specific integrated circuits, etc.). Processor(s) 208 can be configured to execute computer-readable program instructions 212 that are stored in data storage 210 and are executable to provide the functionality of a UAV described herein.

Data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of processor(s) 208. In some embodiments, data storage 210 can be implemented using a single physical device (e.g., one optical, magnetic, organic or other memory or disc storage unit), while in other embodiments, data storage 210 can be implemented using two or more physical devices.

As noted, data storage 210 can include computer-readable program instructions 212 and perhaps additional data, such as diagnostic data of UAV 200. As such, data storage 210 may include program instructions 212 to perform or facilitate some or all of the UAV functionality described herein. For instance, in the illustrated embodiment, program instructions 212 include navigation module 214 and tether control module 216.

In an illustrative embodiment, IMU 202 may include both an accelerometer and a gyroscope, which may be used together to determine an orientation of UAV 200. In particular, the accelerometer can measure the orientation of the vehicle with respect to earth, while the gyroscope measures the rate of rotation around an axis. IMUs are commercially available in low-cost, low-power packages. For instance, IMU 202 may take the form of or include a miniaturized MicroElectroMechanical System (MEMS) or a NanoElectroMechanical System (NEMS). Other types of IMUs may also be utilized.

IMU 202 may include other sensors, in addition to accelerometers and gyroscopes, which may help to better determine position and/or help to increase autonomy of UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmission of the wave and receiving the corresponding echo off an object. A typical application of an ultrasonic sensor for unmanned vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with unmanned vehicles. Such imaging sensor(s) have numerous possible applications, such as obstacle avoidance, localization techniques, ground tracking for more accurate navigation (e.g., by applying optical flow techniques to images), video feedback, and/or image recognition and processing, among other possibilities.

UAV 200 may also include GPS receiver 206. GPS receiver 206 may be configured to provide data that is typical of well-known GPS systems, such as the GPS coordinates of UAV 200. Such GPS data may be utilized by UAV 200 for various functions. As such, the UAV may use GPS receiver 206 to help navigate to the caller's location, as indicated, at least in part, by the GPS coordinates provided by their mobile device. Other examples are also possible.

Navigation module 214 may provide functionality that allows UAV 200 to, for example, move about its environment and reach a desired location. To do so, navigation module 214 may control the altitude and/or direction of flight by controlling the mechanical features of the UAV that affect flight (e.g., its rudder(s), elevator(s), aileron(s), and/or the speed of its propeller(s)).

In order to navigate UAV 200 to a target location, navigation module 214 may implement various navigation techniques, such as map-based navigation and localization-based navigation, for instance. With map-based navigation, UAV 200 may be provided with a map of its environment, which may then be used to navigate to a particular location on the map. With localization-based navigation, UAV 200 may be capable of navigating in an unknown environment using localization. Localization-based navigation may involve UAV 200 building its own map of its environment and calculating its position within the map and/or the position of objects in the environment. For example, as UAV 200 moves throughout its environment, UAV 200 may continuously use localization to update its map of the environment. This continuous mapping process may be referred to as simultaneous localization and mapping (SLAM). Other navigation techniques may also be utilized.

In some embodiments, navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, navigation module 214 and/or other components and systems of UAV 200 may be configured for “localization” to more precisely navigate to the scene of a target location. More specifically, it may be desirable in certain situations for a UAV to be within a threshold distance of the target location where payload 228 is being delivered by a UAV (e.g., within a few feet of the target destination). To this end, a UAV may use a two-tiered approach in which it uses a more-general location-determination technique to navigate to a general area that is associated with the target location, and then use a more-refined location-determination technique to identify and/or navigate to the target location within the general area.

For example, UAV 200 may navigate to the general area of a target destination where payload 228 is being delivered using waypoints and/or map-based navigation. The UAV may then switch to a mode in which it utilizes a localization process to locate and travel to a more specific location. For instance, if UAV 200 is to deliver a payload to a user's home, UAV 200 may need to be substantially close to the target location in order to avoid delivery of the payload to undesired areas (e.g., onto a roof, into a pool, onto a neighbor's property, etc.). However, a GPS signal may only get UAV 200 so far (e.g., within a block of the user's home). A more precise location-determination technique may then be used to find the specific target location.

Various types of location-determination techniques may be used to accomplish localization of the target delivery location once UAV 200 has navigated to the general area of the target delivery location. For instance, UAV 200 may be equipped with one or more sensory systems, such as, for example, ultrasonic sensors 204, infrared sensors (not shown), and/or other sensors, which may provide input that navigation module 214 utilizes to navigate autonomously or semi-autonomously to the specific target location.

As another example, once UAV 200 reaches the general area of the target delivery location (or of a moving subject such as a person or their mobile device), UAV 200 may switch to a “fly-by-wire” mode where it is controlled, at least in part, by a remote operator, who can navigate UAV 200 to the specific target location. To this end, sensory data from UAV 200 may be sent to the remote operator to assist them in navigating UAV 200 to the specific location.

As yet another example, UAV 200 may include a module that is able to signal to a passer-by for assistance in reaching the specific target delivery location. For example, the UAV 200 may display a visual message requesting such assistance in a graphic display or play an audio message or tone through speakers to indicate the need for such assistance, among other possibilities. Such a visual or audio message might indicate that assistance is needed in delivering UAV 200 to a particular person or a particular location, and might provide information to assist the passer-by in delivering UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once UAV 200 arrives at the general area of a target delivery location, UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, UAV 200 may be configured to navigate by “sourcing” such directional signals—in other words, by determining where the signal is strongest and navigating accordingly. As another example, a mobile device can emit a frequency, either in the human range or outside the human range, and UAV 200 can listen for that frequency and navigate accordingly. As a related example, if UAV 200 is listening for spoken commands, then UAV 200 could utilize spoken statements, such as “I'm over here!” to source the specific location of the person requesting delivery of a payload.

In an alternative arrangement, a navigation module may be implemented at a remote computing device, which communicates wirelessly with UAV 200. The remote computing device may receive data indicating the operational state of UAV 200, sensor data from UAV 200 that allows it to assess the environmental conditions being experienced by UAV 200, and/or location information for UAV 200. Provided with such information, the remote computing device may determine altitudinal and/or directional adjustments that should be made by UAV 200 and/or may determine how UAV 200 should adjust its mechanical features (e.g., its rudder(s), elevator(s), aileron(s), and/or the speed of its propeller(s)) in order to effectuate such movements. The remote computing system may then communicate such adjustments to UAV 200 so it can move in the determined manner.

In a further aspect, UAV 200 includes one or more communication system(s) 218. Communications system(s) 218 may include one or more wireless interfaces and/or one or more wireline interfaces, which allow UAV 200 to communicate via one or more networks. Such wireless interfaces may provide for communication under one or more wireless communication protocols, such as Bluetooth, WiFi (e.g., an IEEE 902.11 protocol), Long-Term Evolution (LTE), WiMAX (e.g., an IEEE 902.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, UAV 200 may include communication systems 218 that allow for both short-range communication and long-range communication. For example, UAV 200 may be configured for short-range communications using Bluetooth and for long-range communications under a CDMA protocol. In such an embodiment, UAV 200 may be configured to function as a “hot spot;” or in other words, as a gateway or proxy between a remote support device and one or more data networks, such as a cellular network and/or the Internet. Configured as such, UAV 200 may facilitate data communications that the remote support device would otherwise be unable to perform by itself.

For example, UAV 200 may provide a WiFi connection to a remote device, and serve as a proxy or gateway to a cellular service provider's data network, which the UAV might connect to under an LTE or a 3G protocol, for instance. UAV 200 could also serve as a proxy or gateway to a high-altitude balloon network, a satellite network, or a combination of these networks, among others, which a remote device might not be able to otherwise access.

In a further aspect, UAV 200 may include power system(s) 220. Power system(s) 220 may include one or more batteries for providing power to UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

UAV 200 may employ various systems and configurations in order to transport and deliver payload 228. In some implementations, payload 228 of UAV 200 may include or take the form of a “package” designed to transport various goods to a target delivery location. For example, UAV 200 can include a compartment, in which an item or items may be transported. Such a package may one or more food items, purchased goods, medical items, or any other object(s) having a size and weight suitable to be transported between two locations by the UAV. In other embodiments, payload 228 may simply be the one or more items that are being delivered (e.g., without any package housing the items).

In some embodiments, payload 228 may be attached to the UAV and located substantially outside of the UAV during some or all of a flight by the UAV. For example, the package may be tethered or otherwise releasably attached below the UAV during flight to a target location. In an embodiment where a package carries goods below the UAV, the package may include various features that protect its contents from the environment, reduce aerodynamic drag on the system, and prevent the contents of the package from shifting during UAV flight.

For instance, when payload 228 takes the form of a package for transporting items, the package may include an outer shell constructed of water-resistant cardboard, plastic, or any other lightweight and water-resistant material. Further, in order to reduce drag, the package may feature smooth surfaces with a pointed front that reduces the frontal cross-sectional area. Further, the sides of the package may taper from a wide bottom to a narrow top, which allows the package to serve as a narrow pylon that reduces interference effects on the wing(s) of the UAV. This may move some of the frontal area and volume of the package away from the wing(s) of the UAV, thereby preventing the reduction of lift on the wing(s) cause by the package. Yet further, in some embodiments, the outer shell of the package may be constructed from a single sheet of material in order to reduce air gaps or extra material, both of which may increase drag on the system. Additionally or alternatively, the package may include a stabilizer to dampen package flutter. This reduction in flutter may allow the package to have a less rigid connection to the UAV and may cause the contents of the package to shift less during flight.

In order to deliver the payload, the UAV may include winch system 221 controlled by tether control module 216 in order to lower payload 228 to the ground while UAV 200 hovers above. As shown in FIG. 2, winch system 221 may include tether 224, and tether 224 may be coupled to payload 228 by payload coupling apparatus 226. Tether 224 may be wound on a spool that is coupled to motor 222 of the UAV. Motor 222 may take the form of a DC motor (e.g., a servo motor) that can be actively controlled by a speed controller. Tether control module 216 can control the speed controller to cause motor 222 to rotate the spool, thereby unwinding or retracting tether 224 and lowering or raising payload coupling apparatus 226. In practice, the speed controller may output a desired operating rate (e.g., a desired RPM) for the spool, which may correspond to the speed at which tether 224 and payload 228 should be lowered towards the ground. Motor 222 may then rotate the spool so that it maintains the desired operating rate.

In order to control motor 222 via the speed controller, tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as motor 222 causes rotation of the spool, a rotary encoder may be used to measure this rotation. In doing so, the rotary encoder may be used to convert a rotary position to an analog or digital electronic signal used by tether control module 216 to determine the amount of rotation of the spool from a fixed reference angle and/or to an analog or digital electronic signal that is representative of a new rotary position, among other options. Other examples are also possible.

Based on the data from the speed sensor, tether control module 216 may determine a rotational speed of motor 222 and/or the spool and responsively control motor 222 (e.g., by increasing or decreasing an electrical current supplied to motor 222) to cause the rotational speed of motor 222 to match a desired speed. When adjusting the motor current, the magnitude of the current adjustment may be based on a proportional-integral-derivative (PID) calculation using the determined and desired speeds of motor 222. For instance, the magnitude of the current adjustment may be based on a present difference, a past difference (based on accumulated error over time), and a future difference (based on current rates of change) between the determined and desired speeds of the spool.

In some embodiments, tether control module 216 may vary the rate at which tether 224 and payload 228 are lowered to the ground. For example, the speed controller may change the desired operating rate according to a variable deployment-rate profile and/or in response to other factors in order to change the rate at which payload 228 descends toward the ground. To do so, tether control module 216 may adjust an amount of braking or an amount of friction that is applied to tether 224. For example, to vary the tether deployment rate, UAV 200 may include friction pads that can apply a variable amount of pressure to tether 224. As another example, UAV 200 can include a motorized braking system that varies the rate at which the spool lets out tether 224. Such a braking system may take the form of an electromechanical system in which motor 222 operates to slow the rate at which the spool lets out tether 224. Further, motor 222 may vary the amount by which it adjusts the speed (e.g., the RPM) of the spool, and thus may vary the deployment rate of tether 224. Other examples are also possible.

In some embodiments, tether control module 216 may be configured to limit the motor current supplied to motor 222 to a maximum value. With such a limit placed on the motor current, there may be situations where motor 222 cannot operate at the desired rate specified by the speed controller. For instance, there may be situations where the speed controller specifies a desired operating rate at which motor 222 should retract tether 224 toward UAV 200, but the motor current may be limited such that a large enough downward force on tether 224 would counteract the retracting force of motor 222 and cause tether 224 to unwind instead. A limit on the motor current may be imposed and/or altered depending on an operational state of UAV 200.

In some embodiments, tether control module 216 may be configured to determine a status of tether 224 and/or payload 228 based on the amount of current supplied to motor 222. For instance, if a downward force is applied to tether 224 (e.g., if payload 228 is attached to tether 224 or if tether 224 gets snagged on an object when retracting toward UAV 200), tether control module 216 may need to increase the motor current in order to cause the determined rotational speed of motor 222 and/or spool to match the desired speed. Similarly, when the downward force is removed from tether 224 (e.g., upon delivery of payload 228 or removal of a tether snag), tether control module 216 may need to decrease the motor current in order to cause the determined rotational speed of motor 222 and/or spool to match the desired speed. As such, tether control module 216 may be configured to monitor the current supplied to motor 222. For instance, tether control module 216 could determine the motor current based on sensor data received from a current sensor of the motor or a current sensor of power system 220. In any case, based on the current supplied to motor 222, tether control module 216 may determine if payload 228 is attached to tether 224, if someone or something is pulling on tether 224, and/or if payload coupling apparatus 226 is pressing against UAV 200 after retracting tether 224. Other examples are possible as well.

During delivery of payload 228, payload coupling apparatus 226 can be configured to secure payload 228 while being lowered from the UAV by tether 224, and can be further configured to release payload 228 upon reaching ground level. Payload coupling apparatus 226 can then be retracted to the UAV by reeling in tether 224 using motor 222.

In some implementations, payload 228 may be passively released once it is lowered to the ground. For example, a passive release mechanism may include one or more swing arms adapted to retract into and extend from a housing. An extended swing arm may form a hook on which payload 228 may be attached. Upon lowering the release mechanism and payload 228 to the ground via a tether, a gravitational force as well as a downward inertial force on the release mechanism may cause payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of payload 228 no longer forces the swing arm to extend from the housing. Retracting the swing arm into the housing may reduce the likelihood of the release mechanism snagging payload 228 or other nearby objects when raising the release mechanism toward the UAV upon delivery of payload 228.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, UAV 200 could include an air-bag drop system or a parachute drop system. Alternatively, UAV 200 carrying a payload could simply land on the ground at a delivery location. Other examples are also possible.

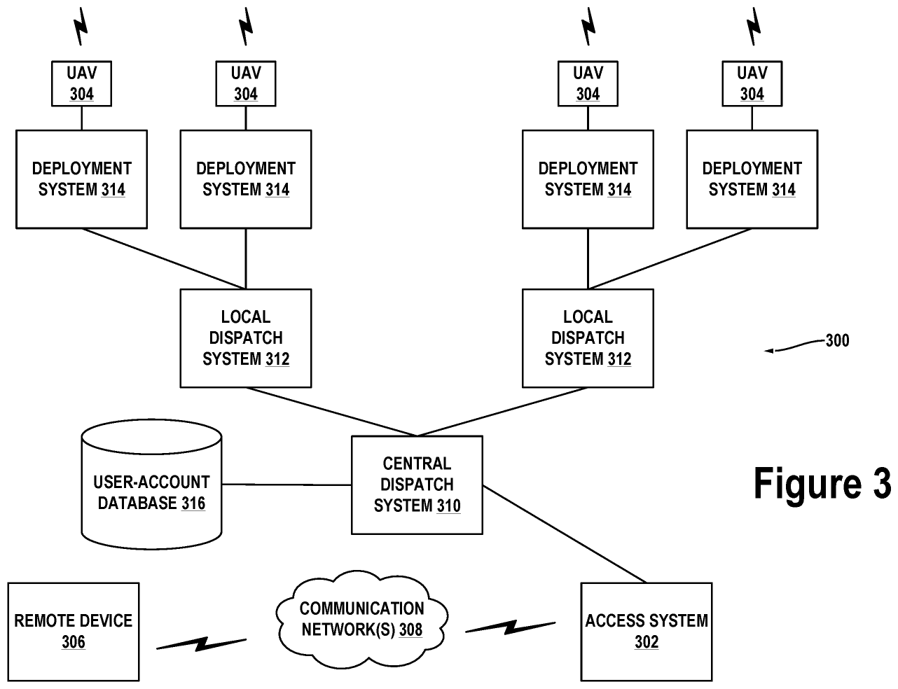

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3 is a simplified block diagram illustrating a distributed UAV system 300, according to an example embodiment.

In the illustrative UAV system 300, access system 302 may allow for interaction with, control of, and/or utilization of a network of UAVs 304. In some embodiments, access system 302 may be a computing system that allows for human-controlled dispatch of UAVs 304. As such, the control system may include or otherwise provide a user interface through which a user can access and/or control UAVs 304.

In some embodiments, dispatch of UAVs 304 may additionally or alternatively be accomplished via one or more automated processes. For instance, access system 302 may dispatch one of UAVs 304 to transport a payload to a target location, and the UAV may autonomously navigate to the target location by utilizing various on-board sensors, such as a GPS receiver and/or other various navigational sensors.

Further, access system 302 may provide for remote operation of a UAV. For instance, access system 302 may allow an operator to control the flight of a UAV via its user interface. As a specific example, an operator may use access system 302 to dispatch one of UAVs 304 to a target location. The dispatched UAV may then autonomously navigate to the general area of the target location. At this point, the operator may use access system 302 to take control of the dispatched UAV and navigate the dispatched UAV to the target location (e.g., to a particular person to whom a payload is being transported). Other examples of remote operation of a UAV are also possible.

In an illustrative embodiment, UAVs 304 may take various forms. For example, each of UAVs 304 may be a UAV such as those illustrated in FIG. 1A, 1B, 1C, 1D, 1E, or 2. However, UAV system 300 may also utilize other types of UAVs without departing from the scope of the invention. In some implementations, all of UAVs 304 may be of the same or a similar configuration. However, in other implementations, UAVs 304 may include a number of different types of UAVs. For instance, UAVs 304 may include a number of types of UAVs, with each type of UAV being configured for a different type or types of payload delivery capabilities.

UAV system 300 may further include remote device 306, which may take various forms. Generally, remote device 306 may be any device through which a direct or indirect request to dispatch a UAV can be made. Note that an indirect request may involve any communication that may be responded to by dispatching a UAV, such as requesting a package delivery. In an example embodiment, remote device 306 may be a mobile phone, tablet computer, laptop computer, personal computer, or any network-connected computing device. Further, in some instances, remote device 306 may not be a computing device. As an example, a standard telephone, which allows for communication via plain old telephone service (POTS), may serve as remote device 306. Other types of remote devices are also possible.

Further, remote device 306 may be configured to communicate with access system 302 via one or more types of communication network(s) 308. For example, remote device 306 may communicate with access system 302 (or a human operator of access system 302) by communicating over a POTS network, a cellular network, and/or a data network such as the Internet. Other types of networks may also be utilized.

In some embodiments, remote device 306 may be configured to allow a user to request pick-up of one or more items from a certain source location and/or delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, UAV system 300 may receive location information (e.g., GPS coordinates, etc.) from the user's mobile phone, or any other device on the user's person, such that a UAV can navigate to the user's location (as indicated by their mobile phone).

In some embodiments, a business user (e.g., a restaurant) could utilize one or more remote devices 306 to request that a UAV be dispatched to pick-up one or more items (e.g., a food order) from a source location (e.g., the restaurant's address), and then deliver the one or more items to a target location (e.g., a customer's address). Further, in such embodiments, there may be multiple instances of remote device 306 associated with a common item provider account (e.g., an account used by multiple employees and/or owners of a particular restaurant). Additionally, in such embodiments, remote device 306 may be utilized to send item provider submissions to a transport provider computing system (e.g., central dispatch system 310 and or local dispatch system 312), which each indicate a respective quantitative measure for a given amount of UAV transport service at a given future time. For example, remote device 306 may be utilized to generate and send an item provider submission that specifies a level of desired UAV transport services (e.g., number and/or rate of expected UAV delivery flights), and/or a monetary value corresponding to the item provider's need for UAV transport services, at a particular time or during a particular period of time in the future.

In an illustrative arrangement, central dispatch system 310 may be a server or group of servers, which is configured to receive dispatch messages requests and/or dispatch instructions from access system 302. Such dispatch messages may request or instruct central dispatch system 310 to coordinate the deployment of UAVs to various target locations. Central dispatch system 310 may be further configured to route such requests or instructions to one or more local dispatch systems 312. To provide such functionality, central dispatch system 310 may communicate with access system 302 via a data network, such as the Internet or a private network that is established for communications between access systems and automated dispatch systems.

In the illustrated configuration, central dispatch system 310 may be configured to coordinate the dispatch of UAVs 304 from a number of different local dispatch systems 312. As such, central dispatch system 310 may keep track of which ones of UAVs 304 are located at which ones of local dispatch systems 312, which UAVs 304 are currently available for deployment, and/or which services or operations each of UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when central dispatch system 310 receives a request for UAV-related service (e.g., transport of an item) from access system 302, central dispatch system 310 may select a specific one of UAVs 304 to dispatch. Central dispatch system 310 may accordingly instruct local dispatch system 312 that is associated with the selected UAV to dispatch the selected UAV. Local dispatch system 312 may then operate its associated deployment system 314 to launch the selected UAV. In other cases, central dispatch system 310 may forward a request for a UAV-related service to one of local dispatch systems 312 that is near the location where the support is requested and leave the selection of a particular one of UAVs 304 to local dispatch system 312.

In an example configuration, local dispatch system 312 may be implemented as a computing system at the same location as deployment system(s) 314 that it controls. For example, a particular one of local dispatch system 312 may be implemented by a computing system installed at a building, such as a warehouse, where deployment system(s) 314 and UAV(s) 304 that are associated with the particular one of local dispatch systems 312 are also located. In other embodiments, the particular one of local dispatch systems 312 may be implemented at a location that is remote to its associated deployment system(s) 314 and UAV(s) 304.

Numerous variations on and alternatives to the illustrated configuration of UAV system 300 are possible. For example, in some embodiments, a user of remote device 306 could request delivery of a package directly from central dispatch system 310. To do so, an application may be implemented on remote device 306 that allows the user to provide information regarding a requested delivery, and generate and send a data message to request that UAV system 300 provide the delivery. In such an embodiment, central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to central dispatch system 310, local dispatch system(s) 312, access system 302, and/or deployment system(s) 314 may be combined in a single system, implemented in a more complex system (e.g., having more layers of control), and/or redistributed among central dispatch system 310, local dispatch system(s) 312, access system 302, and/or deployment system(s) 314 in various ways.

Yet further, while each local dispatch system 312 is shown as having two associated deployment systems 314, a given local dispatch system 312 may alternatively have more or fewer associated deployment systems 314. Similarly, while central dispatch system 310 is shown as being in communication with two local dispatch systems 312, central dispatch system 310 may alternatively be in communication with more or fewer local dispatch systems 312.

In a further aspect, deployment systems 314 may take various forms. In some implementations, some or all of deployment systems 314 may be a structure or system that passively facilitates a UAV taking off from a resting position to begin a flight. For example, some or all of deployment systems 314 may take the form of a landing pad, a hangar, and/or a runway, among other possibilities. As such, a given deployment system 314 may be arranged to facilitate deployment of one UAV 304 at a time, or deployment of multiple UAVs (e.g., a landing pad large enough to be utilized by multiple UAVs concurrently).

Additionally or alternatively, some or all of deployment systems 314 may take the form of or include systems for actively launching one or more of UAVs 304. Such launch systems may include features that provide for an automated UAV launch and/or features that allow for a human-assisted UAV launch. Further, a given deployment system 314 may be configured to launch one particular UAV 304, or to launch multiple UAVs 304.

Note that deployment systems 314 may also be configured to passively facilitate and/or actively assist a UAV when landing. For example, the same landing pad could be used for take-off and landing. Additionally or alternatively, a deployment system could include a robotic arm operable to receive an incoming UAV. Deployment system 314 could also include other structures and/or systems to assist and/or facilitate UAV landing processes. Further, structures and/or systems to assist and/or facilitate UAV landing processes may be implemented as separate structures and/or systems, so long as UAVs can move or be moved from a landing structure or system to deployment system 314 for re-deployment.

Deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, local dispatch systems 312 (along with their respective deployment system(s) 314 may be strategically distributed throughout an area such as a city. For example, local dispatch systems 312 may be strategically distributed such that each local dispatch systems 312 is proximate to one or more payload pickup locations (e.g., near a restaurant, store, or warehouse). However, local dispatch systems 312 may be distributed in other ways, depending upon the particular implementation.

As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, UAV system 300 may include or have access to user-account database 316. User-account database 316 may include data for a number of user accounts, and which are each associated with one or more person. For a given user account, user-account database 316 may include data related to or useful in providing UAV-related services. Typically, the user data associated with each user account is optionally provided by an associated user and/or is collected with the associated user's permission.

Further, in some embodiments, a person may be required to register for a user account with UAV system 300, if they wish to be provided with UAV-related services by UAVs 304 from UAV system 300. As such, user-account database 316 may include authorization information for a given user account (e.g., a user name and password), and/or other information that may be used to authorize access to a user account.

In some embodiments, a person may associate one or more of their devices with their user account, such that they can access the services of UAV system 300. For example, when a person uses an associated mobile phone to, e.g., place a call to an operator of access system 302 or send a message requesting a UAV-related service to a dispatch system, the phone may be identified via a unique device identification number, and the call or message may then be attributed to the associated user account. Other examples are also possible.

Additionally or alternatively, an item provider that wishes to deliver their products using UAV transport services provided by an aerial transport service provider (ATSP) to deliver, can register for an item provider account with UAV system 300. As such, user-account database 316 may include authorization information for a given item provider account (e.g., one or more user name and password combinations), and/or other information that may be used to authorize access to a given item provider account. Alternatively, data for item provider accounts may be kept in a separate database from recipient user accounts. Other data structures and storage configurations for storing such account data are also possible.

An aerial transport service provider (ATSP) may be a separate entity from the entity or entities that provide the items being transported and/or interface with the recipients who request delivery of these items. For example, a company that operates a fleet of UAVs configured for item delivery may provide delivery services for third-party entities, such as restaurants, clothing stores, grocery stores, and other “brick and mortar” and/or online retailers, among other possibilities. These third-party entities may have accounts with the ATSP, via which the third-parties can request and/or purchase UAV transport services from the ATSP. Further, the third-party entities could interface with recipients (e.g., customers) directly, or through computing systems (e.g., applications and/or server systems) provided by the ATSP

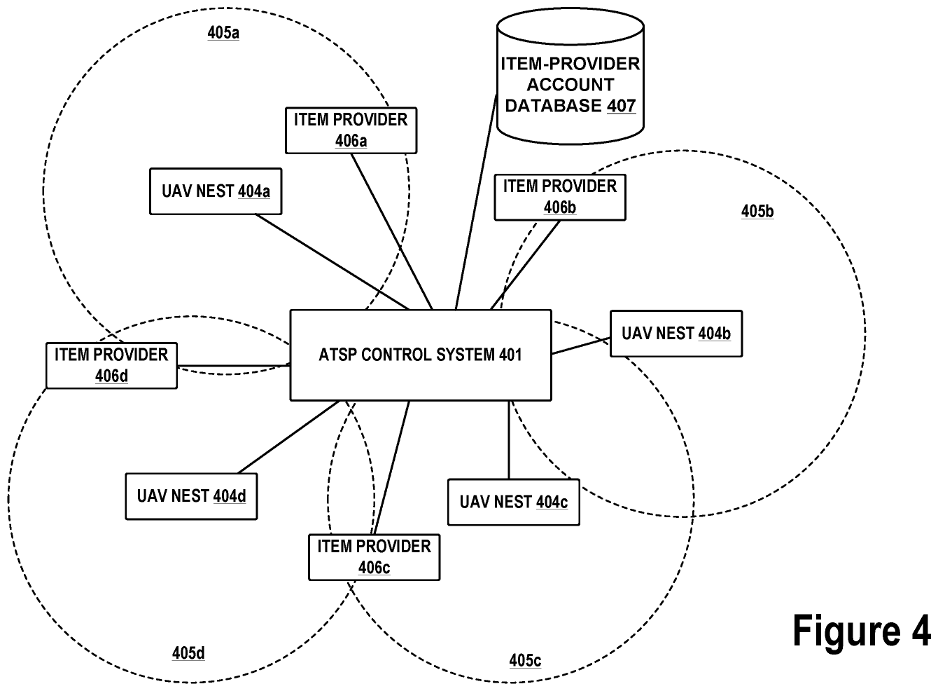

FIG. 4 is a block diagram showing an example arrangement for an aerial transport service provider control system 401, which coordinates UAV transport services for a plurality of item providers that are located remotely from the service provider's central UAV dispatch locations (e.g., UAV nests). The ATSP may be a separate entity from the item providers. As shown, ATSP control system 401 may be communicatively coupled to computing or control systems of UAV nests 404a, 404b, 404c, and 404d (i.e., UAV nests 404a-d), and communicatively coupled to computing systems of item providers 406a, 406b, 406c, and 406d (i.e., item providers 406a-d). Such communicative couplings may be implemented using various types of wired and/or wireless communication protocols and networks.

Each of UAV nests 404a-d is a facility where UAVs can be stored for at least a short period of time, and from which UAVs can begin carrying out a UAV transport task (e.g., where UAVs can take off). In some implementations, some or all of the UAV nests may take the form of a local dispatch system and one or more deployment systems, such as those described in reference to FIG. 3 above. Of course, some or all of the UAV nests could also take other forms and/or perform different functions.

Each of the computing systems of item providers 406a-d may be associated with a different item provider account. As such, one or more of the computing systems associated with item providers 406a-d may include one or more computing devices that are authorized to access the corresponding item provider account with the ATSP. Further, the ATSP may store data for item provider accounts in an item provider account database 407.

In practice, one or more of the computing systems of item providers 406a-d may include one or more remote computing devices (e.g., such as one or more remote devices 306 described in reference to FIG. 3), which have logged in to or otherwise been authorized to access the same item provider account (e.g., cell phones, laptops, and/or computing devices of a business's employees). Additionally or alternatively, one or more of the computing systems of item providers 406a-d may be implemented with less of an ad-hoc approach; e.g., with one or more user-interface terminals installed at the item provider's facilities. Other types of item provider computing systems are also possible.

In order to provide UAV transport services to various item providers in an efficient and flexible manner, ATSP control system 401 may dynamically assign different UAVs to transport tasks for different item providers based on demand and/or other factors, rather than permanently assigning each UAV to a particular item provider. As such, the particular UAV or UAVs that carry out transport tasks for a given third-party item provider may vary over time.

The dynamic assignment of UAVs to flights for a number of different item providers can help an ATSP to more efficiently utilize a group of UAVs (e.g., by reducing unnecessary UAV downtime), as compared to an arrangement where specific UAVs are permanently assigned to specific item providers. More specifically, to dynamically assign UAVs to transport requests from third-party item providers, ATSP control system 401 can dynamically redistribute UAVs amongst a number of UAV deployment locations (which may be referred to as, e.g., “hubs” or “nests”) through a service area, according to time-varying levels of demand at various locations or sub-areas within the service area.

Each respective UAV nest of UAV nests 404a-d is shown as having associated therewith a corresponding geographic area 405a, 405b, 405c, and 405d, respectively (i.e., geographic areas 405a-d), within which UAVs of the respective UAV nest provide transport services to item providers and/or item recipients. The geographic area served by a given UAV nest may be defined, at least in part, by the flight range(s) of the UAVs that are located at or scheduled to be located at the given UAV nest. In some implementations, the geographic areas 405a-d corresponding to UAV nests 404a-d may each have a fixed size, which does not vary over time. In other implementations, the size of each of geographic areas 405a-d could vary over time based on various factors, such as demand for UAV transport services in the geographic area and/or nearby geographic areas, the number and/or capabilities of UAVs allocated to operate from the corresponding UAV nest, and/or the number and/or characteristics of item providers located near to the UAV nest, among other possibilities.

Additionally or alternatively, the size of each of geographic areas 405a-d could vary on an order-by-order basis, and/or vary by item provider. More specifically, when a transport task involves three or more flight legs (e.g., a flight from the UAV nest to the item provider for pick-up, a flight from the item provider to a delivery location, and a return flight to the UAV nest), there may be two or more flight legs before delivering an item. Thus, the evaluation of whether or not a given item provider is within the geographic service area of a UAV nest for a given transport task may depend on a combination of the distance from the UAV nest to the item pick-up location, the distance from the pick-up location to the delivery location, and the distance from the delivery location to the UAV nest. As a result, a given UAV nest may be able to serve a given item provider for one transport task, but not for another. In this context, it is possible that the notion of a defined “geographic service area” might not be utilized at all. Instead, ATSP control system 401 may simply evaluate whether a UAV transport task can be implemented on a task-by-task basis, given all of the parameters for completion of the task.

Since certain item providers can only be served by (or are better served by) a certain UAV nest or nests, and because demand for UAV transport services can vary between item providers, ATSP control system 401 may, for a given geographic/service area, implement an ongoing process to distribute and redistribute UAVs amongst the UAV nests 404a-d that collectively serve the given area. In particular, ATSP control system 401 may continually, periodically, or from time-to-time evaluate demand and/or other factors for each item provider 406a-d, and determine a respective number of UAVs that are desirable at each of UAV nests 404a-d, in order to meet the demand for UAV transport tasks in the corresponding geographic area. Additionally or alternatively, ATSP control system 401 could determine a respective number of UAVs that are desirable at each of UAV nest 404a-d such that UAV nests 404a-d can collectively meet demand for UAV transport services in the larger area collectively served by the UAV nests 404a-d.

### III. Example Systems and Methods for Generating and Updating Flyable Airspace for UAVs

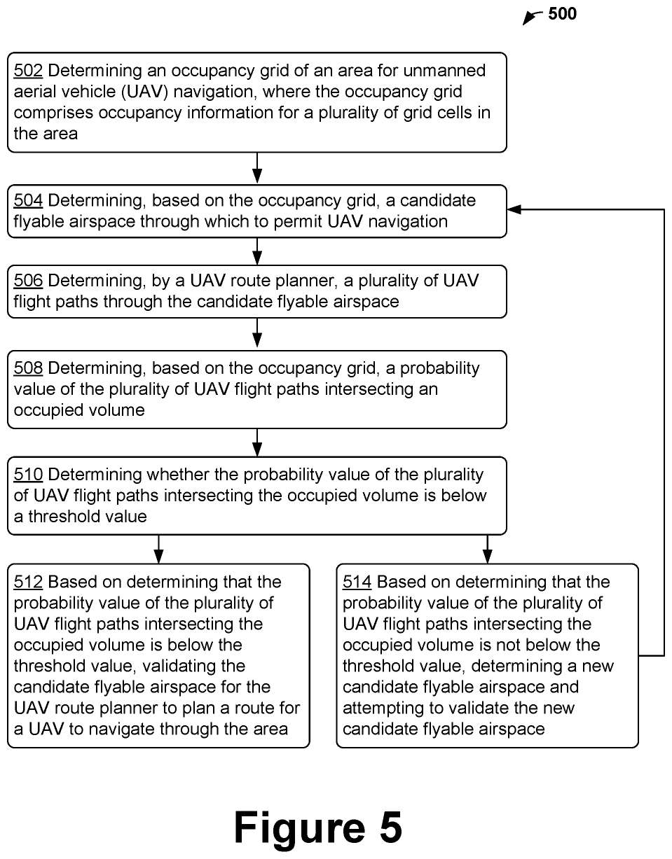

FIG. 5 is a block diagram of method 500, in accordance with example embodiments. In some examples, method 500 may be carried out by a control system. In further examples, method 500 may be carried out by one or more processors, executing program instructions stored in a data storage. Execution of method 500 may involve a UAV, such as the UAV illustrated and described with respect to FIGS. 1-2. Other UAVs may also be used in the performance of method 500. In further examples, some or all of the blocks of method 500 may be performed by a control system remote from the UAV. In yet further examples, different blocks of method 500 may be performed by different control systems, located on and/or remote from a UAV.

At block 502, method 500 includes determining an occupancy grid of an area for unmanned aerial vehicle (UAV) navigation, where the occupancy grid comprises occupancy information for a plurality of grid cells in the area. A fleet of UAVs may operate in the area and may determine the occupancy grid during various missions. Additionally and/or alternatively, one or more UAVs may be tasked with surveying the area, and each UAV may collect sensor data as the UAV is flying over the area to determine the occupancy grid. The occupancy grid may be stored on a server and/or sent to each UAV operating in the area.

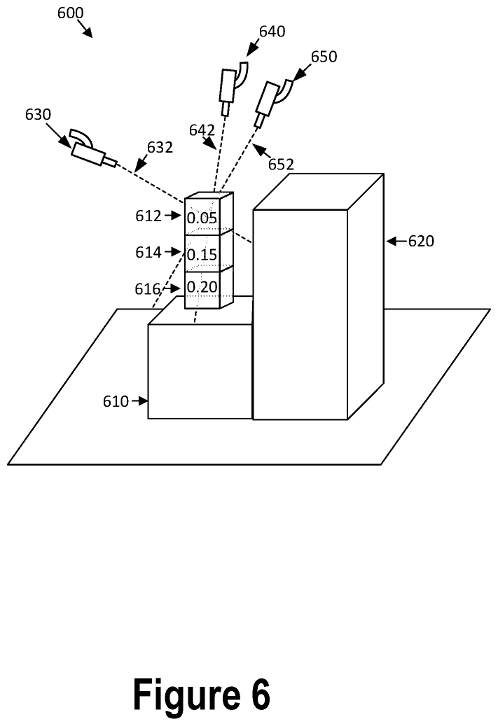

FIG. 6 illustrates part of an example occupancy grid of environment 600, in accordance with example embodiments. Environment 600 may include building 610 and building 620. An occupancy grid for environment 600 may include a representation of the area in which buildings 610 and 620 are located as well as other buildings and areas.

An occupancy grid may split the environment into grid cells, e.g., grid cell 612, 614, and 616, where each grid cell represents an area in the environment. The occupancy grid and its grid cells may be three dimensional, such that each grid cell represents a three dimensional area in the environment. In some examples, the occupancy grid may include a plurality of grid cells in the x, y, and z directions to create a three dimensional representation of the environment. In further examples, the occupancy grid and its grid cells may be two dimensional, perhaps such that each grid cell models the occupancy of a surface in the environment.

An occupancy value may be associated with each grid cell, such that the occupancy value could represent the probability that the area in the environment is occupied. For example, grid cell 612 may be associated with an occupancy value of 0.05, grid cell 614 may be associated with an occupancy value of 0.15, and grid cell 616 may be associated with an occupancy value of 0.20. The occupancy grid may also include grid cells representing the area occupied by building 610 and/or 620. The occupancy values associated with the grid cells representing the area occupied by building 610 and/or 620 may thus have a high probability of being occupied.

The occupancy values of grid cells 612, 614, and 616 may be determined based on sensor data that various UAVs collected while navigating in the environment, perhaps as part of a mission to deliver payload or as part of a mission to survey the area in the environment to create an occupancy grid. Additionally and/or alternatively, the occupancy values of grid cells 612, 614, 616, and other grid cells in the occupancy grid may also be determined based on sensor data collected by other sensors in the environment (e.g., satellites, balloons, etc.).

As an example, occupancy values of grid cells 612, 614, and 616 may be determined by sensors 630, 640, and 650. Each of sensors 630, 640, and 650 may be part of a UAV or other device capable of surveying the environment. Each sensor may also have a different field of view of the environment. For example, when sensor 630 collects sensor data of the area over environment 610, sensor 630 may only capture the area represented by grid cell 612. Whereas, when sensor 640 passes the area over environment 610, sensor 640 may capture the area represented by grid cells 612, 614, and 616. Sensor 650 may capture the area represented by grid cells 612 and 614.

In some examples, the occupancy values may correspond to a certainty measurement of whether an obstacle exists in the area represented by the grid cell. For example, because sensor data may have been collected of the area represented by grid cell 612 by sensor 630, 640, and 650, the occupancy value of grid cell 612 may be higher than the occupancy value of grid cell 616, for which only sensor 640 has collected data. The certainty measurement of whether an obstacle exists in the area may be determined based on various other factors as well, including, whether variations in the sensor data, lighting conditions when the sensor data was collected, weather conditions when the sensor data was collected, predetermined maps of the environment, and staleness of data, among other factors.

At block 504, method 500 includes determining, based on the occupancy grid, a candidate flyable airspace through which to permit UAV navigation. The candidate flyable airspace may include an area above an altitude that a UAV may navigate through. For example, if a map, perhaps based on the occupancy grid, indicates that in an area, the tallest obstacle is 10 meters, then the candidate flyable airspace may be any altitude above 10 meters. Additionally and/or alternatively, the candidate flyable airspace may also impose a maximum limit, e.g., the highest altitude at which the UAV may safely fly.

In some examples, the computing system may determine altitudes of obstacles in the environment and associated margins, and the candidate flyable airspace may be the area above the altitudes by at least the associated margins.

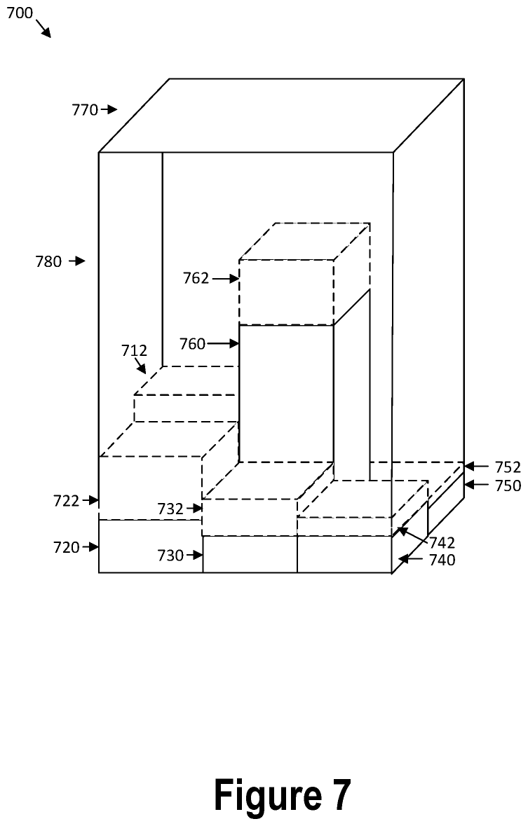

For example, FIG. 7 illustrates estimated altitudes and margins defining a candidate flyable airspace, in accordance with example embodiments. The estimated altitudes are represented by altitude blocks 720, 730, 740, and 760. The computing device may determine that the altitude blocks 720, 730, 740, and 760 may be occupied. Additionally and/or alternatively, each of altitude blocks 720, 730, 740, and 760 may include an area having one or more buildings, trees, or other obstacles that have a maximum height as indicated by the respective altitude block.

In some examples, the computing system may determine the altitudes based on the occupancy grid. The computing system may apply an occupancy value threshold to the occupancy grid to determine the maximum altitude at which the area in the environment is occupied. For instance, at the area in the environment represented by altitude block 720, the occupancy grid may include one or more grid cells within altitude block 720, where each grid cell is associated with an occupancy value that is greater than the occupancy value threshold. The occupancy grid may also include grid cells in the area above the altitude block 720, where each grid cell is associated with an occupancy value less than the occupancy value threshold.

Other methods of determining the altitudes are also possible. For example, the computing system may determine the altitudes based on additional information, such as DSMs or other maps of the environment. DSMs and other maps of the environment may include an indication of height or altitude information for various areas in the environment. Further additionally and/or alternatively, the computing system determines height information (e.g., height of altitude block 720 and/or other altitude blocks) based on information of the surrounding area (e.g., grid cells of the occupancy grid outside the grid cells included in the altitude block).

As mentioned above, candidate flyable airspace 780 may also be based on margins. The margins indicate that a UAV should fly at least a certain vertical distance above associated altitudes. For instance, for an area having an altitude of ten meters (perhaps due to a building being at the area), the associated margin may indicate that the UAV should fly at least one meter above the ten meters (e.g., that the UAV should fly at an altitude of 11 meters or above at the area). In environment 700, margins are represented by margin blocks 712, 722, 732, 742, 752, and 762. Candidate flyable airspace 780 may thus include the area above the margin blocks 712, 722, 732, 742, 752, and 762 and the estimated altitude information as represented by altitude blocks 720, 730, 740, and 760.

Various methods of determining margin information are possible. For instance, the computing system may determine the margin information based on a DSM or other pre-determined maps of the environment. As mentioned above, the DSM or other pre-determined maps of the environment may include confidence information, and the computing system may determine the margin information to be inversely proportional to the confidence information (e.g., determining greater heights or altitudes for a particular area when the confidence information indicates low confidence for the area). In some examples, the computing system may determine margin information so that margins have infinite heights if no information is available (e.g., maximum uncertainty occupancy grids). Additionally and/or alternatively, the computing system may determine the margin information based on the occupancy grid and/or on the estimated altitude information. For example, the computing system may apply a threshold value to grid cells above the height or altitude indicated by the estimated altitude information, and the margin information may indicate one or more heights or altitudes below which the grid cells are above the threshold occupancy value or above which the grid cells are below the threshold occupancy value. A threshold value used to set margin information may be distinct from any threshold used to determine surface altitudes. Further additionally and/or alternatively, the computing system may determine the margin information based on information of the one or more obstacles in the area. For example, areas predicted to contain power lines may be associated with margin values that are greater than areas predicted to contain buildings. Other methods of determining margin information are also possible.

Candidate flyable airspace 780 may be defined by a lower altitude limit at a particular location such that candidate flyable airspace 780 may be an area above the lower altitude limit. The lower altitude limit may be the estimated altitude of a surface in the environment at the particular location padded by the associated margin. For example, a lower altitude limit at a grid cell may be the sum of the estimated altitude at the grid cell and the margin at the grid cell. The lower altitude limit may be determined from DSMs, which in turn may be estimated from associated occupancy grids.

In some examples, candidate flyable airspace 780 may also have an upper altitude limit. Flight paths for UAVs may not cross the upper altitude limit. In environment 700, the upper limit may be indicated by upper altitude limit 770. In some examples, the upper altitude limit may be the highest altitude at which a UAV has the ability to fly. Additionally and/or alternatively, the upper altitude limit may be the highest altitude at which the UAV can safely fly. Other upper altitude limits are also possible. In some examples, upper altitude limits may be determined from DSMs, which in turn may be estimated from associated occupancy grids.

At block 506, method 500 includes determining, by a UAV route planner, a plurality of UAV flight paths through the candidate flyable airspace. The UAV route planner may take an input of a plurality of starting areas, a plurality of orders, and a plurality of delivery locations, among other inputs, which the UAV route planner may use to determine the flight paths. For instance, the computing system may assume a peak order flow (e.g., the order flow during the busiest period of the day), starting areas corresponding to UAV nests, and delivery locations corresponding to various residential and/or commercial addresses. The computing system may also assume a plurality of merchants and/or a plurality of merchant locations from which to pick up the payload. From these inputs, the computing system may then determine a plurality of UAV flight paths by applying the UAV route planner.

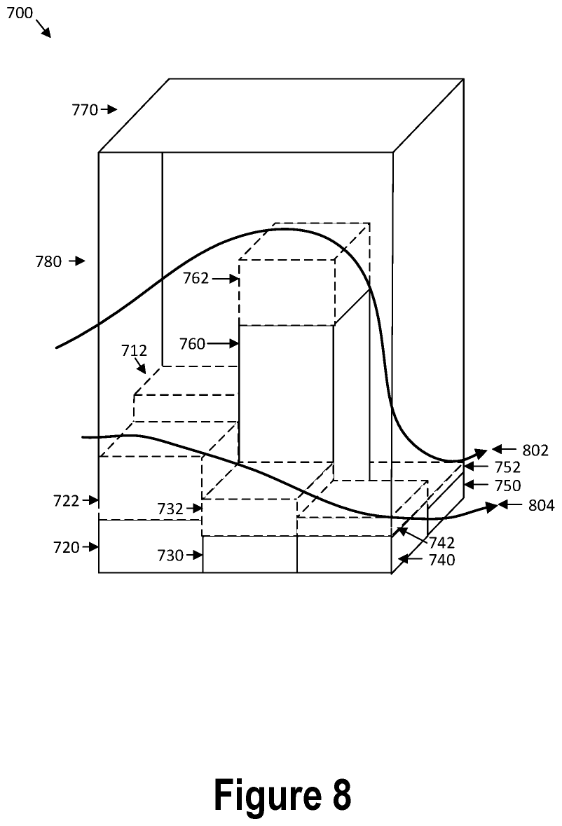

For instance, FIG. 8 illustrates flight paths 802 and 804, in accordance with example embodiments. The computing device may determine flight paths 802 and 804 by providing the inputs above into the UAV route planner, which may determine flight paths 802 and 804. Each flight path may be within the candidate flyable airspace. Namely, each of flight paths 802 and 804 may be at a height at each area that is above the height indicated by the sum of the height or altitude indicated by altitude blocks 720, 730, 740, 750, and 760 and the height or altitude indicated by margin blocks 712, 722, 732, 742, 752, and 762. For example, at the area represented by altitude block 720 and margin block 722, flight path 804 may be above the sum of the altitude indicated by altitude block 720 and the altitude indicated by margin block 722.

At block 508, method 500 includes determining, based on the occupancy grid, a probability value of the plurality of UAV flight paths intersecting an occupied volume. As mentioned above, the occupancy grid may include various occupancy values, such that an occupancy value of a grid cell may represent the probability that the area in the environment is occupied. The computing system may thus determine the probability value of an area in the environment by determining an occupancy value in the occupancy grid at a height indicated by the candidate flyable airspace at the area. Additionally and/or alternatively, the computing system may determine the probability value of the area in the environment by averaging the occupancy values in the occupancy grid at a height above the candidate flyable airspace. Further additionally and/or alternatively, the computing system may determine a distribution function that the area is occupied.

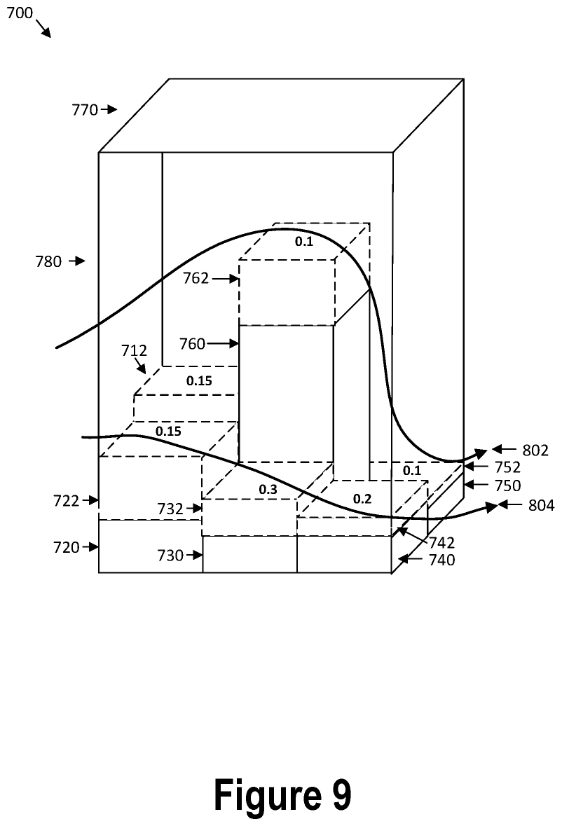

FIG. 9 illustrates probabilities of UAV intersection with occupied areas, in accordance with example embodiments. As illustrated in FIG. 9, the candidate flyable airspace area above the area represented by altitude block 720 and margin block 722 may have a probability value of 0.15, which may represent the probability that a UAV will intersect with an obstacle while flying over this candidate flyable airspace area. Similarly, the candidate flyable airspace area above the area represented by altitude block 730 and margin block 732 may have a probability value of 0.3, and the candidate flyable airspace area above the area represented by altitude block 740 and margin block 742 may have a probability value of 0.2. The candidate flyable airspace area above the area represented by altitude block 750 and margin block 752 may have a probability value of 0.1, and the candidate flyable airspace area above the area represented by altitude block 760 and margin block 762 may have a probability value of 0.1. Margin block 712 may be above an altitude block, and the candidate flyable airspace area above the area may have an associated probability value of 0.15.

In some examples, determining the probability value of the plurality of UAV flight paths intersecting an occupied volume based on the occupancy grid may involve running various simulations, perhaps for each batch of flight paths determined from different batches of merchants, delivery locations, and/or order flows. In particular, the probability value of the plurality of UAV flight paths intersecting an occupied volume may be a Bernoulli random variable which takes a value of 1 if flight paths for a fixed number of flight paths in a specified area of operation results in the respective flight path intersecting with the occupied volume. The probability of the flight paths intersecting the occupied volume may be represented by PFIOV, and for a set of observations represented by Z, the probability of flight paths intersecting the occupied volume given a set of observations may be represented by P(PFIOV=1|Z) can be estimated as p=P(PFIOV=1|Z)=Σ_{w∈W}P(W=w|Z) P(PFIOV=1|W=w), where W is a random variable capturing a voxelized model representation such that each voxel is occupied or vacant. To determine P(W=w|Z), the computing system may execute a simulation based on a sampling based approach, a per voxel independence approximation based approach, and/or a multi-run based approach.

Executing a simulation based on a sampling based approach may involve sampling each of grid cells above which the flight paths occur. Sampling a grid cell over a plurality of flight paths may include the computer system determining one or more values for whether the grid cell is occupied. For example, for block 712, the computing system may sample block 712 for each flight path that passes over block 712 (e.g., flight path 802), and the computing system may determine various occupancy samples, each indicating whether an area of the occupancy sample is occupied. For instance, for block 712, an occupancy sample associated with the area indicated by block 712 may be “occupied.” When the computing system determines the occupancy sample 20 times (perhaps due to running a simulation twenty times, having twenty flight paths over the area indicated by block 712, or otherwise sampling the grid cell twenty times), the computing system may determine that the block 712 is occupied 3 times and unoccupied 17 times, or some other proportion of times such that the proportion of occupied and unoccupied comes out to 0.15. Based on the occupancy samples determined based on sampling the grid cells, the computing system may determine a probability of a flight path (e.g., flight path 802) intersecting the occupied volume (e.g., the occupied volume including altitude blocks 720, 730, 740, 750, and 760 and margin blocks 712, 722, 732, 742, 752, and 762). In some examples, the computing system may determine a biased sampling distribution such that the samples are weighted by a likelihood ratio. In an example where P*(W|Z) represents the biased sampling distribution, p=E_{w-P(W|Z)}(P(PFIOV=1|W=w))=E_{w-P*(W|Z)}([P(W=w|Z)/P*(W=w|Z)] P(PFIOV=1|W=w)). The optimal sampling distribution may be P*(W=w|Z)=P(W=w|PFIOV=1, Z).

To execute a per voxel independence approximation based approach, the computing system may simulate whether each grid cell is occupied independently from other grid cells in the occupancy grid. In particular, if Vₚ represents a random variable capturing which grid cells are visited by flight plans generated in a given area of operation with given weather conditions, and for a fixed number of flights, each with given mission specifications, then P(PFIOV=1|Z)=1−Π_{□ϵ□}(1−P(PFIOVᵥ=1|Z)), where PFIOVᵥ captures PFIOV for a grid cell v.

To execute a multi-run based approach, the computing system may simulate flight paths determined from different batches of merchants, delivery locations, and/or order flows, among other conditions. The computing system may perform a Monte Carlo simulation to compute the probability value of the plurality of UAV flight paths intersecting an occupied volume. Taking N as the number of times a planner is run, to obtain vₚⁱ, for i in

$$\{ 1 , 2 , … N \} , P ( PFIOV = 1 \vert Z ) = 1 - \frac{1}{N} {\sum }_{i = 1}^{N} \qquad {\prod }_{v ∈ {v}_{p} i} \qquad P ( {O}_{v} = 0 \vert Z ) .$$

This multi-run based approach may also assume that whether a grid cell is occupied is independent of another grid cell, perhaps adjacent grid cell, is occupied. The computing system may determine an average probability value based on the probability value for each run or flight path set, such that the average probability is the probability value of the plurality of UAV flight paths intersecting the occupied volume.

Based on the simulation and the obtained probability value of the plurality of UAV flight paths intersecting an occupied volume, the computing system may determine whether to continue with the candidate flyable airspace for a UAV route planner to plan routes for UAVs to navigate through or to determine another candidate flyable airspace. In some examples, the computing system may determine whether the probability value of the plurality of UAV flight paths intersecting the occupied volume is below a threshold value. Based on the determination that the probability value of the plurality of UAV flight paths intersecting the occupied volume is below the threshold value, the computing system may use the candidate flyable airspace to plan routes for the UAV or other UAVs to navigate through the area. Additionally and/or alternatively, based on the determination that the probability value of the plurality of UAV flight paths intersecting the occupied volume is not below the threshold value, the computing system may adjust the candidate flyable airspace and validate the adjusted candidate flyable airspace.

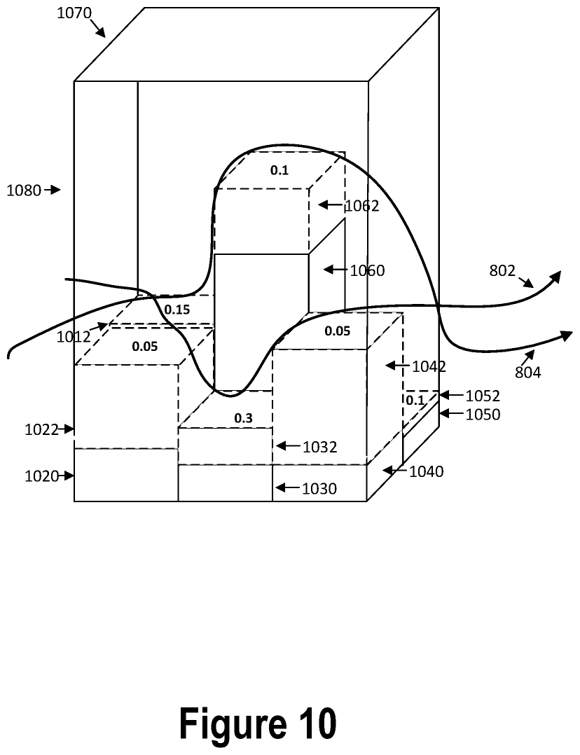

For instance, FIG. 10 illustrates altitude and adjusted margin information of an adjusted candidate flyable airspace 1080, in accordance with example embodiments. In particular, the altitude may include altitude blocks 1020, 1030, 1040, 1050, and 1060, which the computing system may determine or otherwise designate as occupied. The adjusted margin information may include adjusted margin blocks 1012, 1022, 1032, 1042, 1052, and 1062. The adjusted candidate flyable airspace may include the area above the margin blocks 1012, 1022, 1032, 1042, 1052, and 1062 (e.g., the area above the sum of the height indicated by altitude blocks 1020, 1030, 1040, 1050, and 1060 and adjusted margin blocks 1012, 1022, 1032, 1042, 1052, and 1062 for each grid cell).

Based on the determination that the probability value of the plurality of UAV flight paths intersecting the occupied volume is not below the threshold value, the computing system may adjust the candidate flyable airspace to be the adjusted candidate flyable airspace 1080. In particular, determining the adjusted candidate flyable airspace 1080 may involve adjusting the margin blocks to be higher and/or lower, such that the probability value of the plurality of UAV flight paths intersecting the occupied volume is below the threshold value. For instance, the computing system may have determined adjusted margin blocks 1022 and 1042 to be higher than margin blocks 722 and 742, perhaps in an attempt to determine a probability value of the plurality of UAV flight paths intersecting the occupied volume that is below the threshold value. The computing system may then determine a new probability value of another plurality of UAV flight paths intersecting the occupied volume as indicated by the adjusted candidate flyable airspace 1080. The computing system may determine whether the probability value is below the threshold value. If the determination is that the probability value is below the threshold value, the computing system may use the candidate flyable airspace 1080 to determine the candidate flyable airspace 1080 to plan a route for a UAV to navigate through the area.

In further examples, the computing system may verify that the candidate flyable airspace was determined less than a threshold amount of time ago. Various changes in an area may occur, including various buildings being built, trees growing, and powerlines may be erected. In verifying that the candidate flyable airspace was determined less than the threshold amount of time ago, the computing system may verify that the candidate flyable airspace is still current. When there is a high probability that the area has changed (e.g., when the candidate flyable airspace is from more than a threshold amount of time from a current time), the computing system may determine another candidate flyable airspace through the process discussed above to decrease the possibility of accidentally colliding with obstacles in the changed environment. In some examples, the process of verifying that the candidate flyable airspace was determined less than a threshold amount of time ago may be incorporated into the occupancy grid and/or the occupancy values in the occupancy grid.

Referring back to FIG. 5, at block 512, method 500 includes, based on determining that the probability value of the plurality of UAV flight paths intersecting the occupied volume is below the threshold value, validating the candidate flyable airspace for the UAV route planner to plan a route for a UAV to navigate through the area. As mentioned above, if the probability value of the plurality of UAV flight paths intersecting the occupied volume is below the threshold volume, the computing system may use the candidate flyable airspace to plan various routes.

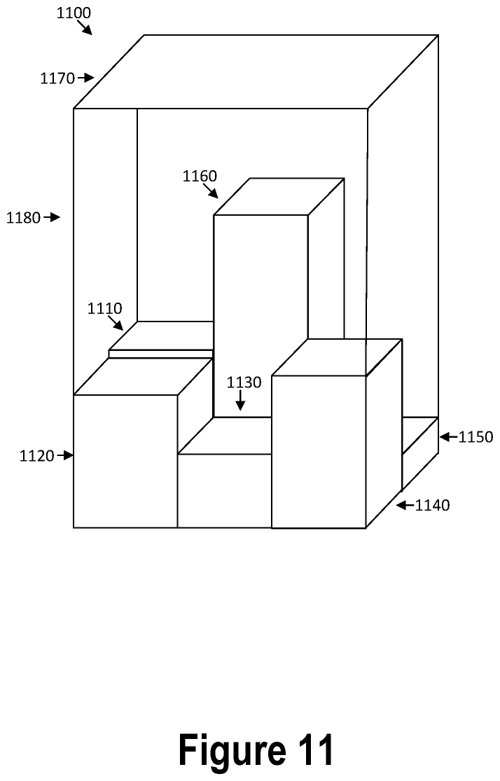

FIG. 11 illustrates flyable airspace 1180, in accordance with example embodiments. More specifically, flyable airspace 1180 may be set once adjusted candidate flyable airspace 1080 of FIG. 10 is validated (e.g., it is determined that the probability value of adjusted candidate flyable airspace 1080 of FIG. 10 is below the threshold value). Flyable airspace 1180 may include the space above occupied volume blocks 1110, 1120, 1130, 1140, 1150, and 1160 and the space below the upper altitude limit. The flyable airspace 1170 may include the area above the altitude blocks and the margin blocks. More specifically, occupied volume blocks 1110, 1120, 1130, 1140, and 1160 may include the altitude blocks 1020, 1030, 1040, 1050, and 1060 and the adjusted margin blocks 1012, 1022, 1032, 1042, 1052, and 1062. In particular, the occupied volume block 1120 may include altitude block 1022 and adjusted margin block 1012, occupied volume block 1130 may include altitude block 1032 and adjusted margin block 1022, and so on.

After having determined and verified flyable airspace 1180, the computing system may use flyable airspace 1180 as a basis to determine a flight path through the area. In particular, the computing system may use a UAV route planner to plan a route for the UAV to navigate through the environment. The UAV route planner may be a similar or different route planner as the route planner used to determine simulated UAV flight paths through the flyable airspace. Additionally and/or alternatively, the computing system may send the flyable airspace to UAVs in a fleet of UAVs operating in the area of the flyable airspace, such that each UAV in the fleet of UAVs may be able to generate routes based on the validated candidate airspace.

Referring back to FIG. 5, the blocks of method 500 may include one or more additional blocks and/or limitations. Method 500 may also include one or more additional blocks and/or limitations.

In some examples, determining the candidate flyable airspace comprises determining, based on the occupancy grid, an estimated digital surface model comprising estimated altitudes and determining margin associated with the estimated altitudes. The candidate flyable airspace is an area above the estimated altitudes padded by the associated margins.

In some examples, the estimated digital surface model comprises one or more grid cells. Each cell is associated with an estimated altitude value at the grid cell and each grid cell is associated with a margin value of the margin information.

In some examples determining the probability value of UAV flight paths intersecting the occupied volume comprises determining, based on the occupancy grid, a probability value associated with each grid cell that an area at the grid cell is occupied at a height of the margin value above the estimated altitude value.

In some examples, determining the plurality of UAV flight paths through the candidate flyable airspace is based on a plurality of starting areas, a plurality of orders, and a plurality of delivery locations.

In some examples, determining the probability value of the plurality of UAV flight paths intersecting the occupied volume is based on one or more probability values. Each probability value of the one or more probability values represents a probability that one or more grid cells in the area is occupied at a height below the occupied volume.

In some examples, determining the probability value of the plurality of UAV flight paths intersecting the occupied volume comprises determining one or more occupancy samples of the area based on the one or more probability values.

In some examples, each occupancy sample of the one or more occupancy samples indicates whether an area of the occupancy sample is occupied.

In some examples, determining the probability value of the plurality of UAV flight paths intersecting the occupied volume is based on an assumption that an occupancy of a grid cell is independent of occupancy of other grid cells in the one or more grid cells.

In some examples, the plurality of UAV flight paths comprises a plurality of flight path sets. Determining the probability value of the plurality of UAV flight paths intersecting the occupied volume comprises determining, based on the occupancy grid, a probability value for each flight path set and determining an average probability value based on the probability value for each flight path set. The average probability value is the probability value of the plurality of UAV flight paths intersecting the occupied volume.

In some examples, determining the plurality of UAV flight paths through the candidate flyable airspace is based on a plurality of order flows. Each flight path set is based on a different order flow.

In some examples, determining, based on the occupancy grid, a probability value of the plurality of UAV flight paths intersecting an occupied volume is based on executing a Monte-Carlo simulation over the plurality of UAV flight paths.

In some examples, determining the candidate flyable airspace comprises, based on determining that an initial probability value of an initial plurality of UAV flight paths intersecting an occupied volume is above the threshold value, adjusting an initial candidate flyable airspace to be the candidate flyable airspace.

In some examples, the initial candidate flyable airspace is based on estimated altitude information and margin information, adjusting the initial candidate flyable airspace to be the candidate flyable airspace comprises adjusting the estimated altitude information or the margin information.

In some examples, determining the plurality of UAV flight paths through the candidate flyable airspace comprises verifying that the candidate flyable airspace was determined less than a threshold amount of time ago and, based on the verifying, determining the plurality of UAV flight paths through the candidate flyable airspace.

In some examples, method 500 further comprises based on the validated candidate flyable airspace, determining a flight path for the UAV and causing the UAV to navigate the flight path.

In some examples, determining the occupancy grid of the area is based on sensor data from a fleet of UAVs.

### V. Conclusion

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software or hardware modules in the same physical device. However, other information transmissions may be between software modules or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method comprising:
determining an occupancy grid of an area for unmanned aerial vehicle (UAV) navigation, wherein the occupancy grid comprises occupancy information for a plurality of grid cells in the area;
determining, based on the occupancy grid, a candidate flyable airspace through which to permit UAV navigation;
determining, by a UAV route planner, a plurality of UAV flight paths through the candidate flyable airspace;
determining, based on the occupancy grid, a probability value of the plurality of UAV flight paths intersecting an occupied volume;
determining whether the probability value of the plurality of UAV flight paths intersecting the occupied volume is below a threshold value;
based on determining that the probability value of the plurality of UAV flight paths intersecting the occupied volume is below the threshold value, validating the candidate flyable airspace for the UAV route planner to plan a route for a UAV to navigate through the area.

2. The method of claim 1, wherein determining the candidate flyable airspace comprises:
determining, based on the occupancy grid, an estimated digital surface model comprising estimated altitudes; and
determining margin associated with the estimated altitudes, wherein the candidate flyable airspace is an area above the estimated altitudes padded by the associated margins.

3. The method of claim 2, wherein the estimated digital surface model comprises one or more grid cells, wherein each cell is associated with an estimated altitude value at the grid cell, wherein each grid cell is associated with a margin value of the margin information.

4. The method of claim 3, wherein determining the probability value of UAV flight paths intersecting the occupied volume comprises:
determining, based on the occupancy grid, a probability value associated with each grid cell that an area at the grid cell is occupied at a height of the margin value above the estimated altitude value.

5. The method of claim 1, wherein determining the plurality of UAV flight paths through the candidate flyable airspace is based on a plurality of starting areas, a plurality of orders, and a plurality of delivery locations.

6. The method of claim 1, further comprising:
based on determining that the probability value of the plurality of UAV flight paths intersecting the occupied volume is not below the threshold value, determining a new candidate flyable airspace and attempting to validate the new candidate flyable airspace.

7. The method of claim 1, wherein determining the probability value of the plurality of UAV flight paths intersecting the occupied volume is based on one or more probability values, wherein each probability value of the one or more probability values represents a probability that one or more grid cells in the area is occupied at a height below the occupied volume.

8. The method of claim 7, wherein determining the probability value of the plurality of UAV flight paths intersecting the occupied volume comprises:
determining one or more occupancy samples of the area based on the one or more probability values.

9. The method of claim 8, wherein each occupancy sample of the one or more occupancy samples indicates whether an area of the occupancy sample is occupied.

10. The method of claim 9, wherein determining the probability value of the plurality of UAV flight paths intersecting the occupied volume is based on an assumption that an occupancy of a grid cell is independent of occupancy of other grid cells in the one or more grid cells.

11. The method of claim 1, wherein the plurality of UAV flight paths comprises a plurality of flight path sets, wherein determining the probability value of the plurality of UAV flight paths intersecting the occupied volume comprises:
determining, based on the occupancy grid, a probability value for each flight path set; and
determining an average probability value based on the probability value for each flight path set, wherein the average probability value is the probability value of the plurality of UAV flight paths intersecting the occupied volume.

12. The method of claim 11, wherein determining the plurality of UAV flight paths through the candidate flyable airspace is based on a plurality of order flows, wherein each flight path set is based on a different order flow.

13. The method of claim 1, wherein determining, based on the occupancy grid, a probability value of the plurality of UAV flight paths intersecting an occupied volume is based on executing a Monte-Carlo simulation over the plurality of UAV flight paths.

14. The method of claim 1, wherein determining the candidate flyable airspace comprises:
based on determining that an initial probability value of an initial plurality of UAV flight paths intersecting an occupied volume is above the threshold value, adjusting an initial candidate flyable airspace to be the candidate flyable airspace.

15. The method of claim 14, wherein the initial candidate flyable airspace is based on estimated altitude information and margin information, adjusting the initial candidate flyable airspace to be the candidate flyable airspace comprises adjusting the estimated altitude information or the margin information.

16. The method of claim 1, wherein determining the plurality of UAV flight paths through the candidate flyable airspace comprises:
verifying that the candidate flyable airspace was determined less than a threshold amount of time ago; and
based on the verifying, determining the plurality of UAV flight paths through the candidate flyable airspace.

17. The method of claim 1, further comprising:
based on the validated candidate flyable airspace, determining a flight path for the UAV; and
causing the UAV to navigate the flight path.

18. The method of claim 1, wherein determining the occupancy grid of the area is based on sensor data from a fleet of UAVs.

19. A computing device comprising:
one or more processors; and
data storage including at least computer-executable instructions stored thereon that, when executed by the one or more processors, cause the computing device to perform functions comprising:
determining an occupancy grid of an area for unmanned aerial vehicle (UAV) navigation, wherein the occupancy grid comprises occupancy information for a plurality of grid cells in the area;
determining, based on the occupancy grid, a candidate flyable airspace through which to permit UAV navigation;
determining, by a UAV route planner, a plurality of UAV flight paths through the candidate flyable airspace;
determining, based on the occupancy grid, a probability value of the plurality of UAV flight paths intersecting an occupied volume;
determining whether the probability value of the plurality of UAV flight paths intersecting the occupied volume is below a threshold value;
based on determining that the probability value of the plurality of UAV flight paths intersecting the occupied volume is below the threshold value, validating the candidate flyable airspace for the UAV route planner to plan a route for a UAV to navigate through the area.

20. A non-transitory computer readable medium having stored thereon instructions, that when executed by one or more processors of a computing device, cause the computing device to perform functions comprising:
determining an occupancy grid of an area for unmanned aerial vehicle (UAV) navigation, wherein the occupancy grid comprises occupancy information for a plurality of grid cells in the area;
determining, based on the occupancy grid, a candidate flyable airspace through which to permit UAV navigation;
determining, by a UAV route planner, a plurality of UAV flight paths through the candidate flyable airspace;
determining, based on the occupancy grid, a probability value of the plurality of UAV flight paths intersecting an occupied volume;
determining whether the probability value of the plurality of UAV flight paths intersecting the occupied volume is below a threshold value;
based on determining that the probability value of the plurality of UAV flight paths intersecting the occupied volume is below the threshold value, validating the candidate flyable airspace for the UAV route planner to plan a route for a UAV to navigate through the area.
